(19) United States
(12) Patent Application Publication
(10) Pub. No.: US 2004/0164166 A1
(43) Pub. Date: Aug. 26, 2004

(54) Indicator for communicating system status information

(75) Inventors: Richard J. Mahany, Swisher, IA (US); Ronald L. Mahany, Cedar Rapids, IA (US); John S. Bandringa, Everett, WA (US); Joseph M. Dusio, Cedar Rapids, IA (US); Pamela S. Mahany, Cedar Rapids, IA (US)

Correspondence Address: Michael F. Williams, Simmons, Perrine, Albright & Ellwood, P.L.C., Suite 1200, 115 Third Street SE, Cedar Rapids, IA, 52401-1266, US

(73) Assignee: Intermec IP Corp.

(21) Appl. No.: 10/623,484

(22) Filed: Jul. 18, 2003

Related U.S. Application Data
(60) Provisional application No. 60/396,982, filed on Jul. 18, 2002.

(51) Int. Cl. G06K 7/10

(52) U.S. Cl. 235/472.02

(57) ABSTRACT

A method and apparatus for indicating device and system readiness to a user is disclosed. An indicator is located on one or more devices of a data-handling system. The state of the indicator communicates the status of the device or system. The indicator can be standardized across two or more devices of the data-handling system. The indicator can be comprised of a single element or of multiple elements.

### CROSS REFERENCE TO RELATED APPLICATIONS

This application claims the benefit of U.S. Provisional Application No. 60/396,982, filed Jul. 18, 2002. The content of U.S. Provisional Application No. 60/396,982, filed Jul. 18, 2002, including any and all drawings, written description, claims and appendices, is hereby incorporated herein in its entirety by this reference.

### BACKGROUND OF THE INVENTION

A great variety of data-handling systems are currently being used in a wide variety of applications. The systems can be used, for example, to automatically or manually gather, communicate, store and manipulate information. Although providing many benefits and services, the various data-handling systems and the devices that populate them are quite often highly complex. A single device may have several different components and peripherals. Further, a single data-handling system can include many different member devices and many different types of member devices.

As a result, such systems and devices generally require a trained or experienced technician to set up the system and to provide maintenance and troubleshooting services when problems develop. Unfortunately, organizations that use data-handling systems often do not have technicians with sufficient training or experience to perform such tasks. What is needed is an invention that enables an individual without significant technical training or experience (a “non-technical” user) to provide such services. Of course, such an invention could be used by technical users as well.

Further, it is believed that a review of this specification, including its claims and drawings, will reveal and imply additional deficiencies of the prior systems that are improved or remedied by the inventions disclosed herein.

### SUMMARY OF THE INVENTION

This specification presents several embodiments related to a signaling system or indicator that can aid a user of a data-handling system. The indicator can include one or more lights or other signaling elements that can be activated or deactivated (turned on or off) to communicate information about the data-handling system to the user. In one embodiment, the indicator informs a user as to whether the component or device on which it is housed has successfully completed a setup or initialization sequence. In another embodiment, the indicator tells a user whether the component or device on which it is housed is currently functioning properly. In another embodiment, the indicator on a device of a multi-device data-handling system tells the user whether the multi-device system as a whole has successfully completed a setup or initialization sequence. In yet another embodiment, the indicator on a device of a multi-device data-handling system tells the user whether the multi-device system as a whole is functioning properly.

In still another embodiment, the indicator can communicate with a user to aid the user in determining the reason or reasons that a given data-handling device or multi-device system is not functioning properly or has failed to successfully complete a setup or initialization routine. Thus, the indicator can be used to troubleshoot a device or system experiencing problems. It can also help increase a user's confidence in the system by providing an indication that the system is functioning properly. In this embodiment, the user can initiate a troubleshooting routine via a local user interface and the indicator can indicate the results of the routine. In a related embodiment, the system additionally provides a user with further information or instruction concerning the troubleshooting procedure via an audio system or via text or graphics displayed on a visual display component of the device.

In addition, the inventions herein also disclose a signaling system that is standardized across members of a multi-device data-handling system. This standardization can be accomplished, for example, by using the same type of indicator on each device of the data-handling system. For example, standardization can be achieved by using for the indicator a light of a certain color on each device, by using the same shape of light or lights on each device, by using the same number of lights on each device, by using the same orientation or configuration or arrangement of lights on each device, or by placing the lights or light on the same relative location on each device.

In one embodiment, the determination of the indicator's state is performed by the same device on which the indicator is housed. In another embodiment, the state of the indicator is determined by a different device of the system. In yet another embodiment, the indicator state is determined sometimes by the device housing the indicator and at other times by a different device of the system. In still another embodiment, the indicator state is determined by examining status indications from more than one source.

Further, the present invention provides a system and method that enables a user to initiate the setup of a complex data-handling system. The invention enables the user to identify whether the setup process has been successful. In the case of a failed setup, the invention can assist the user in identifying the stage that the failure in the setup process occurred.

The signaling system can enable even a user without significant technical experience or training to set up a data-handling system. Without a simple and readily-understood fault diagnostic system, a user may require a significant degree of IT expertise, and may be required to undertake a series of complex troubleshooting exercises to root out a problem. Without an indicator such as is disclosed herein, problems caused by something as simple as a misconfigured scanner could take hours to diagnose.

The indicator of the present inventions can be used in a wide range of physical settings and with a wide variety of data-handling systems. The inventions are particularly useful in facilities and organizations lacking sufficient information technology (IT) resources to apply to an implementation of a complex system such as an industrial automation system. To be deployed in an optimum manner, such systems should be easy to set up, and status indications should be readily and intuitively understood for the case of a successful setup—and advantageously should also be capable of assisting in the diagnosis of the problem when the setup procedure fails at some point.

In an approach that can be used for relatively complex wireless network components, a standard indicator configuration may be employed in which the setup status of the system is to be indicated to a non-technical user. For example, lights may be positioned in a standardized compact configuration on each complex wireless network component in industrial-automation or auto-identification system implementations that are to be set up by non-technical users.

In a related embodiment, which can utilize a simplified setup status indicator configuration, components of a wireless network system having standardized indicator configurations may be taken from their shipping container or containers in a certain order to be first self-tested as an individual component and then tested for connectivity and operation with the prior installed component or components, until the entire system has been systematically installed and tested. In this embodiment, a problem in setup may be identified from its place in the sequential order of installation and testing.

In a further development of the simplified setup status indicator embodiment, when a malfunction appears, a single indicator such as a light may switch from a slow blink during the process of a setup test for example, to a fast blink if an error occurs for example, or to a steady illumination to tell the user that the setup test for example was successful. In the event that a fault occurs that is not readily diagnosed, the non-technical user, for example, can call a service help desk and be instructed to take specified steps such as actuating a certain key or combination of keys for example, to call up a diagnostic program, which then will follow a troubleshooting procedure and signal the result with the use of the single light, which the user can report by telephone to the service technician at the service help desk for example. The non-technical user, by following the telephone instructions from the service technician and reporting the status of the indicator light (e.g. fast blink, slow blink or solid-steady) at each diagnostic step, can readily carry out a complex diagnosis while attending to only a single light in a prominent location. Having had experience with one product, the user will have learned to proceed in the case of a further product to be added to a wireless network system.

Other embodiments aspects, advantages and novel features of the present inventions will become apparent from the following detailed description of the invention when considered in conjunction with the accompanying drawings.

### BRIEF DESCRIPTION OF THE DRAWINGS

FIG. 1 depicts a data-handling system the devices of which include an indicator.

FIG. 2 depicts a device having a single-element indicator.

FIG. 3 is a diagrammatic partial plan view of a first type of hand-held component having a first multi-element standardized setup status indicator configuration which may be applied to a series of different types of components.

FIG. 4 is a diagrammatic partial plan view of a second type of hand-held component different from the first type of component of FIG. 3, and showing a second standardized multi-element setup status indicator configuration which may be applied to a series of different types of components such as an intelligent wireless networked hand-held device, and a wireless client device that, for example, is not adapted for hand-held operation.

FIG. 5 is a diagrammatic showing of a wireless network product such as an access point which may have ports for connection with a premises wired network, and may have one or more built-in antennas for radio frequency coupling with fixed or mobile nodes of a wireless network, the product having a standardized indicator configuration, for example a light of a selected standard color of illumination such as blue, for signaling product status to a non-technical user.

FIG. 6 is a diagrammatic showing of a wireless network product of a different type from that of FIG. 4, for example a hand-held computer which during setup of a wireless network system may have connectivity with the access point of FIG. 4 confirmed by means of a standardized single-element indicator, the indicator having for example a configuration having a size, shape, color of light and a status signaling methodology substantially corresponding to that of the indicator configuration of FIG. 4.

FIG. 7 shows diagrammatically a printer which may be wirelessly coupled with the hand-held computer of FIG. 6, and which may have substantially the same standardized single indicator configuration as the respective different types of products of FIGS. 5 and 6.

FIG. 8 is a diagrammatic indication of a peripheral device differing from the products of FIGS. 5-7, for example a wireless hand-held optical or RFID tag reader, which may be wirelessly coupled with the device of FIG. 6 during setup of a system, and which may have a standardized single indicator configuration substantially corresponding to those of FIGS. 5-7, for signaling its operational readiness.

FIG. 9 depicts a data-handling system utilizing a management application to help determine system readiness.

FIG. 10 depicts a communication protocol that can be used to communicate with a management application.

FIG. 11 depicts another communication protocol that can be used to communicate with a management application.

### DETAILED DESCRIPTION

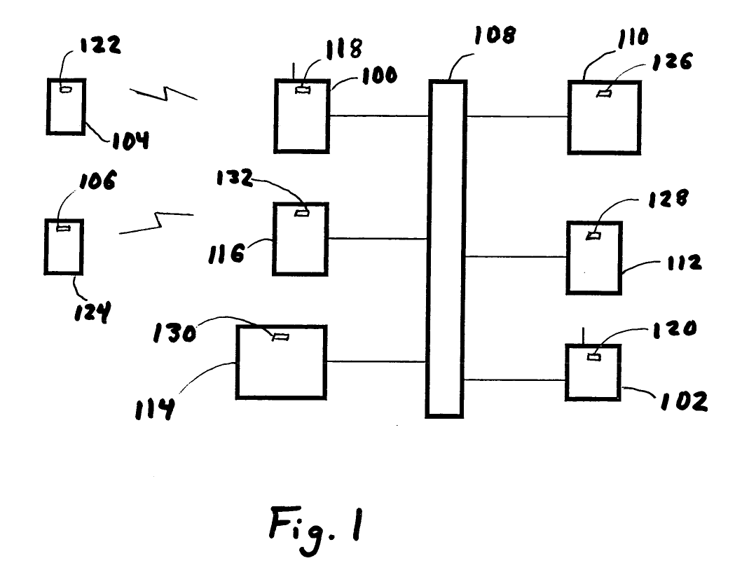

FIG. 1 depicts an example of a data-handling system. The data-handling system of FIG. 1 includes both a wireless communication portion and a wired communication portion. The data-handling system can make use of any of a wide range of known networking systems to facilitate communication between its devices. An Ethernet protocol, for example, could be used with the network arrangement 108 depicted in FIG. 1. Many other networking arrangements and protocols, however, could alternatively be used.

The wireless portion of the system depicted in FIG. 1 includes two wireless access points 100, 102 and two devices 104, 124 containing a wireless communication component. The two devices 104, 124 containing the wireless communication components can be portable, hand-held or fixed-location devices. They may be, for example, printers, any of a wide range of hand-held data collection terminals, servers, personal components, access points, etc.

The devices connected to the wired portion of the system of FIG. 1 can include the access points 100, 102, a personal computer 110, a server 112, a printer 114, a dock for portable data collection terminals 116, as well as other devices. In FIG. 1, each of the depicted devices includes an indicator 118, 120, 122, 106, 126, 128, 130, 132. The indicator operates in any of the manners described throughout this specification. Although every device depicted in FIG. 1 houses an indicator, this is not a requirement of the present inventions. The present inventions are intended for situations wherein one, some or all of the data-collection system devices include an indicator.

As is appreciated by those skilled in the art, the data-handling system of FIG. 1 can be readily modified. Many different types of such systems exist. Some data-handling systems have fewer associated components or devices and others have more. Further, some data-handling systems will be composed of devices different from those depicted in FIG. 1. Some data-handling systems use only wireless communication between the members of the system, other systems rely only on wired communication links, and other data-handling systems (such as the system depicted in FIG. 1 for example) use a combination of wireless and wired communication links.

In summary, a great variety of different data-handling systems can be created. The number and type of devices to be included in the data-handling system is a function of the needs of the particular application at hand. Since FIG. 1 provides but one example of a data-handling system, the structure and content provided therein is not intended to limit the scope of the present inventions. The indicator of the present inventions is capable of being used with many different types of devices and data-handling systems.

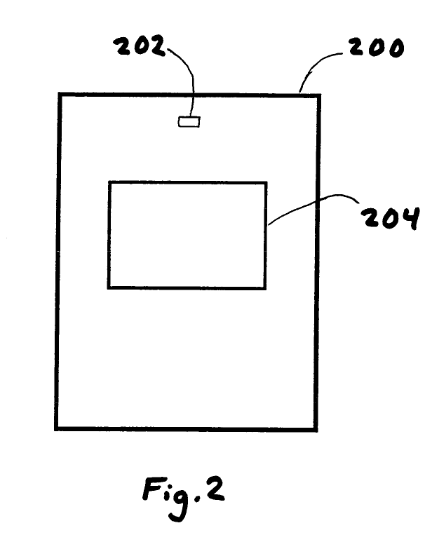

FIG. 2 depicts a device 200 having a single-element indicator 202. The device 200 also includes a display screen 204. It is not required, however, that the device 200 include a display screen 204. For example, if the device 200 is an access point device or a printing device, a display screen might not be included. Other devices 200 may additionally include one or more of a keyboard, keypad, touch screen, digitizer, wireless communication component, wire communication component, optical indicia reader, radio frequency identification (RFID) tag reader or any of a multitude of other components.

The single-element indicator 202 can be, for example, a single light. Alternatively, the single-element indicator 202 can be a speaker that generates a tone or tones to indicate status or a vibrator such as is included in mobile telephones and pagers. If desired, in a device 200 including a display screen, the single-element indicator can be a “virtual indicator” that is displayed on a portion of the display screen.

When the indicator is a light, for example an LED, it can be constructed to have a particular shape and/or color. If desired, the shape, the color, or both the shape and the color of the light can be standardized across each device of a family of products that may cooperate as a data-handling system. For example, the shape of the light can be a circle, square, rectangle, triangle, company or product logo, or any other shape desired. In an embodiment including a standardized light, the consistent use of the same shape of indicator on each device in the system can help the user to readily identify the indicator on any system device.

In a similar manner, the color of the light or the indicator can be used to enable the indicator to be readily identified on each device of the data-handling system. For example, the same color can be used for each indicator in a data handling system. The color can be any of a wide variety of colors. In some applications, it may be desirable to use a color that matches or complements the color of a product or a company logo. In other applications, it may be desirable to use a color that already has somewhat of a defined meaning (for example the “stoplight” colors of red for stop, yellow for caution and green for okay). In other applications, it may be desirable to use a color that is not strongly associated with a particular meaning.

In an application where a light-based indicator must be viewed from a distance (for example an access point that may be located near a ceiling or at some other location that is generally remote from the user), the color, size and intensity of the light can be chosen so that it can be easily identified and viewed at a distance. The same color chosen for the access point can then also be used on each of the other devices of the system. A high intensity blue light, for example, is suitable for use as an indicator that will be viewed at a distance. A blue light carries the additional advantage that it is not a “stoplight” color and is not generally associated with other pre-defined meanings.

Such an indicator system can provide important benefits for a user. For example, at the time of a successful initial system setup, the user receives visual confirmation that all devices of the system are configured correctly. The complete system may contain devices besides the data collection/auto-identification components, such as a customer host, or a remote database to be accessed, and the setup status indication can inform the user that the complete system is ready for use.

In addition, if a problem exists, even a non-technical user can be given an indication as to the nature of the problem. For example, the problem may be a function of, or defect in, the operation of an access point, of host or database connectivity to the access point, of a wireless hand-held device, of wireless security credentials, of application software, or of a data collection component of the system. The user can then take a proper course of action to address the problem.

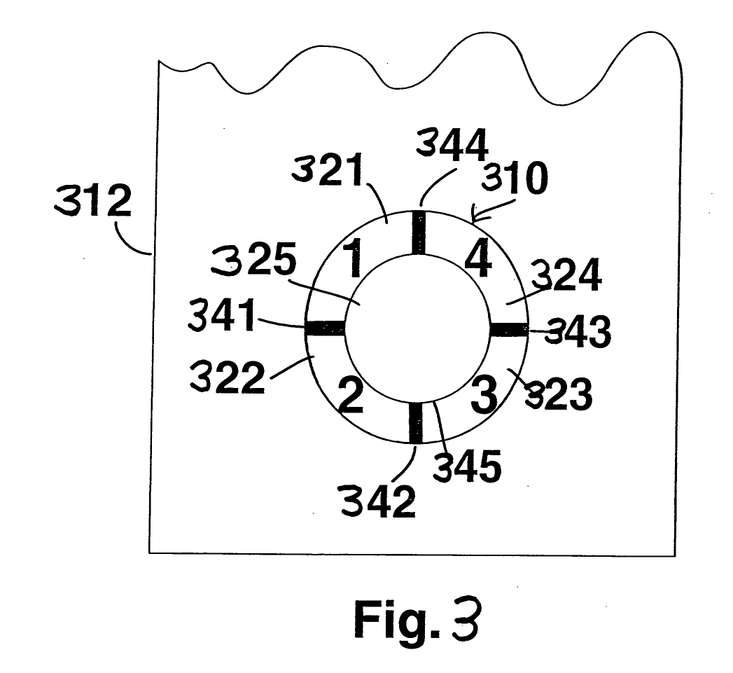

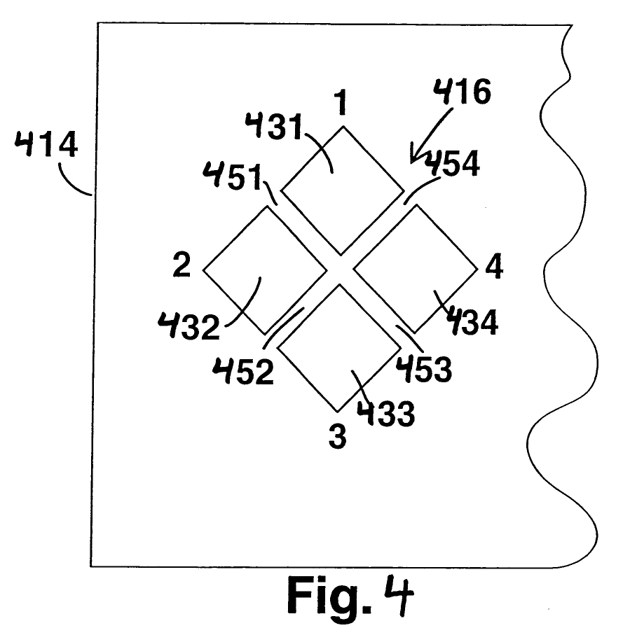

FIGS. 3 and 4 depict two different embodiments of a four-element indicator. These specific four-element embodiments are provided only by way of example. It will be appreciated that many, many other embodiments of indicator configurations can also be used with the teachings provided throughout this specification. In addition to the single-element embodiment of FIG. 2 and the four-element indicators of FIGS. 3 and 4, other embodiments include various two-element, three-element, five-element, six-element and other multi-element indicators. In addition, other four-element indicators having configurations different from those of FIGS. 3 and 4 can also be used. Thus, the number of elements to be included in the indicator can be tailored to meet the needs of the specific application at hand.

FIG. 3 shows a four-element setup status indicator configuration 310 of nonspecific or generic character so as to be suited to being applied to a wide range of diverse products including for example a specific model or type of wireless networked hand-held computer device as diagrammatically indicated at 312. The four-element indicator configuration 310 of FIG. 3, however, could also be used on any of the various types of devices that may be found in a data handling system.

FIG. 4 depicts a four-element indicator 416, but this indicator 416 is configured differently than the four-element indicator 310 of FIG. 3. FIG. 4 may be taken as representing a different type of product such as a non-hand-held wireless client device 414 that may, for example, rest on a table or be carried on the belt of the user. The four-element indicator configuration 416 of FIG. 4, however, could also be used on any of the various types of devices that may be found in a data handling system.

As one example embodiment, the multi-element setup status indicator configuration 310 depicted in FIG. 3 may be applied to both a hand-held type of product 312, FIG. 3, and to a plurality of different hand-held products, and/or to a plurality of different types of products including the non-hand-held type of product 414 represented in FIG. 4.

As another example embodiment, a second multi-element setup status indicator configuration 416 such as is depicted in FIG. 4, may be applied to the specific type of hand-held computer device 312, FIG. 3, and to a plurality of different hand-held products, and/or to a plurality of different types of products including the hand-held type of product 312 represented in FIG. 3 and the non-hand-held type of product 414 represented in FIG. 4.

In each of the preceding two example embodiments, a non-technical user may utilize a setup status indicator configuration 310, 416 of the types depicted in FIG. 3 or FIG. 4 to indicate various stages and results of the setup of the wireless hand-held device, for example, to operate in a given wireless network or system.

An Exemplary Setup Sequence may comprise, for example, the following steps.

a) The device self tests to determine its operational readiness.

b) The connection of the device with a network access point is initiated, and adequacy of the signal strength of the wireless transmissions to the access point may be determined.

c) Next, the device may send an authentication message to the network and receive confirmation that the device or user meets the security requirements of the wireless network.

d) Another setup step can include the loading of application software into the device. For example, after step (c) the application software could be downloaded from the network via the wireless link with the access point.

e) Further, any peripheral devices which are to be associated with the device can be checked to determine if they are connected with the device and if they are in working condition.

f) Where the device is to communicate with a host or hosts on the network, a setup step can determine that such host or hosts are in operation and ready for such communication.

g) When all of steps (a)-(f) are successfully completed, the user can be notified that the entire system is ready.

From the standpoint of a non-technical user that does not have expert help available on the premises, a simple setup status indicator configuration system can be provided that gives the user the information needed in case of a failure of the setup process. Generally, it is advantageous for the user to know that the particular product that the user is attending to is or is not ready to use. If there is a defect in the product preventing setup, it may be a simple matter for the user to obtain a replacement. Of course, a user having technical training or experience can also use any of the embodiments of the indicator system.

Thus, for example, one element of the indicator, such as element 321, FIG. 3, or 431, FIG. 4, may for the various products of a group, in each case, advise the technical or non-technical user as to the readiness of the product (such as 312 or 414) on which it is housed. In this embodiment, the device is essentially considered as an isolated element of the overall system. For example, the element indicated as sector 321, FIG. 3, or 431, FIG. 4, may be caused to appear to blink while the device is executing its power-on tests. In the event of a successful completion of the power-on tests, that element (for example sector 321 or 431) may appear to be steadily illuminated, e.g. supplied with light pulses at a high enough rate so that the user does not observe any flickering of the illumination. Should the device exhibit a failure in the power-on test, this may be readily perceived by the user from the continued blinking of the element 321 or 431, or the pattern of the illumination of the element 321 or 431 may be changed for example from a relatively slower blinking rate to a substantially faster blinking rate signifying a failure in an affirmative manner. As another example, a centrally located element 325 may be illuminated along with continued blinking of the first element 321, for example, to affirmatively advise the user of the failure of the test in progress. As another example, the element 321 could be made to turn off to indicate a test failure. Many different such signaling schemes can be used to indicate testing, testing success and testing failure. As a further example, the same type of signaling can be performed by an audio component (such as a speaker) or by a tactile stimulating component (such as a vibrator). Thus, light-energy, audio or tactile signaling can be used as indicator elements for any of the embodiments disclosed herein.

For the technical or non-technical user, a second indicator element or segment 322 or 432 may signify to the user whether or not the wireless communication connection of any wireless product of the group is successful or presenting a problem. Referring to the Exemplary Setup Sequence supra, this segment 322 or 432 may blink during steps (b) and (c), for example, and present the appearance of steady illumination upon successful completion of the wireless connection process, or indicate a failure in a step of the process as explained above with regard to segment 321 or 431 (for example by changing to a higher rate of blinking). If there is a failure in the wireless connectivity, the non-technical user may have only one course of action to take and further information may not be of substantial assistance to the user.

From the foregoing Exemplary Setup Sequence, it can be appreciated that a standardized setup status indicator configuration with two elements will still provide substantial benefits to a non-technical user and will meet the needs of many users. Thus, in some systems it may be decided to use an indicator having only two elements. The functioning and meaning of the two elements can be as described above, for example, or can be any of a multiple of other signaling or functioning schemes.

An additional element 323 or 433 may relate to steps (d), (e) and (f) of the Exemplary Setup Sequence, supra. To promote simplicity and ease of interpretation by the user, the modes of signaling success or failure can be the same as for the other two elements 321, 322 and 431, 432 described in the preceding paragraphs. However, if desired this element (or any of the elements) could use a signaling scheme that is different than that used by the other elements of the indicator.

From the foregoing Exemplary Setup Sequence, it can be appreciated that a standardized setup status indicator configuration with three elements will also provide substantial benefits to a non-technical user and will meet the needs of a majority of such users. Thus, in some systems it may be decided to use an indicator having only three elements. The functioning and meaning of the three elements can be as described above, for example, or can be any of a multiple of other signaling or functioning schemes. In yet another embodiment, an indicator can have only two elements, the two elements providing the functionality of either the first and third or the second and third elements as described in the preceding paragraphs.

In order that the setup status indicator configuration may be of optimum service to non-technical users in relatively complex wireless network systems, additional indicator segments such as a fourth segment or element 324 or 434 may be included. An example of a setup process utilizing four indicators is as follows:

### Exemplary Operation of the Setup Status Indicator Configuration of FIG. 3 or FIG. 4, for an Intelligent Networked Device such as Hand-Held Computer Device 310, FIG. 3

Indicator Element/Light 1—Device Readiness

Slow Blinking—Device is executing power-on tests.

Fast Blinking—Power-on tests not successfully completed.

Steady—Device successfully completed power-on tests.

Indicator Element/Light 2—Network Connectivity

Slow Blinking

Device is connecting to access point.

Device is assessing adequacy of coverage.

Device/user is authenticating to authentication server.

Fast Blinking—Connection to the network not successful.

Steady—Device is successfully connected to the network.

Indicator Element/Light 3—Application Readiness

Slow Blinking

Application is loading.

Loaded application uses the correct version.

Application is connected to the appropriate host/database.

Necessary peripherals (e.g. bar code scanner, mag stripe reader, etc.) are detected and accounted for.

Fast Blinking—Application is not ready.

Steady—Application is ready.

Indicator Element/Light 4—System Readiness

Slow Blinking—User definable tests are in progress, for example:

Testing that the printer is on-line and ready, is in progress.

System performance is being checked as to being within specified parameters.

Other operational conditions are being checked.

Fasting Blinking—Tests are not successful.

Steady—System is ready for use.

The above exemplary operation for four indicator elements, can also be adapted for use by a single-element indicator. The slower signaling (for example, blinking) could be displayed whenever any type of testing was in progress. The faster signaling could be used to indicate any type of failure. Finally, a “steady on” state could be used to indicate that the system is ready for use.

The areas between the indicator segments as indicated at 341, 342, 343, 344, 345 may represent portions of a light pipe structure or lens structure sealed into the top panel of device 312, which structure serves to confine light from respective blue or other color light sources (not shown) to the areas of segments 321, 322, 323, 324, respectively, and so as to confine light from a green or red light source, for example, to segment 325. Similarly for indicator configuration 416 of FIG. 4, the spaces between indicator segments 431, 432, 433, 434, such as indicated 451, 452, 453, 454, may be occupied by portions of a light pipe structure or a lens structure that confines light from respective (for example a blue or other color light) light sources (not shown) to the respective segments 431, 432, 433, 434.

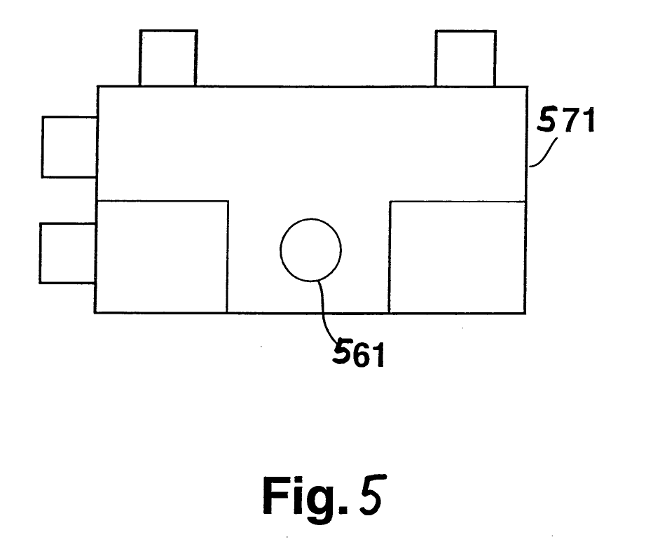

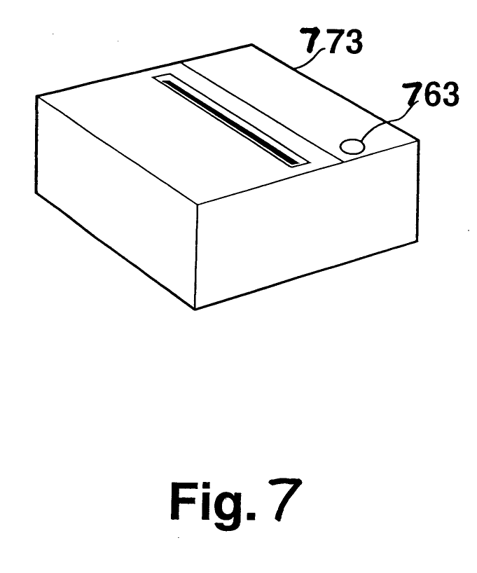

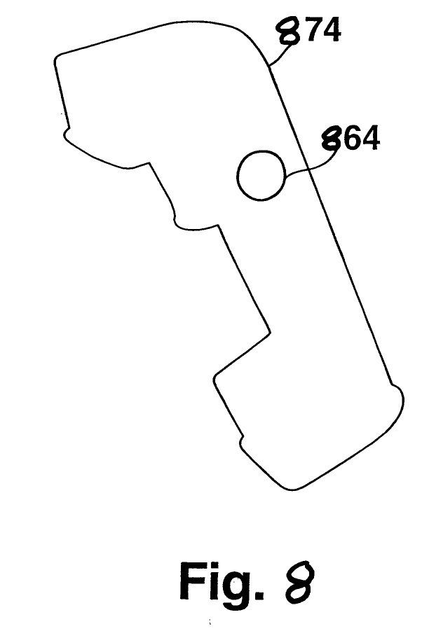

For an embodiment with a simplified setup status indicator configuration such as a single-element indicator having three modes of illumination (for example steady on, slow blink and fast blink), a circular indicator configuration such as represented at 561, 662, 763, 864 in FIGS. 5-8, could be used, for example, with a single (e.g. blue or other color) light source, and having a substantially standard size and shape, and each device of FIGS. 5 through 8 utilizing substantially corresponding signaling modes (e.g. slow blink, fast blink, and a very rapid pulsing of the light source to provide substantially a steady illumination to the observer).

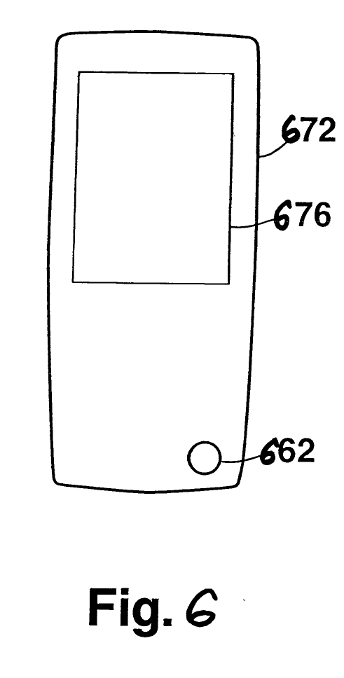

In one embodiment and as is represented in FIGS. 5 through 8, each of the substantially standard status indicators 561, 662, 763, 864 for the respective different types of products 571, 672, 773, 874 represented in FIGS. 5 through 8 can have compact dimensions in comparison to the width dimension of the smallest product, (for example the hand-held computer device 672, FIG. 6, wherein the indicator is less than one-fourth of such width) so as to be easily applied, in terms of space occupied, to a family of different products. At the same time, the indicator being relatively unobtrusive in terms of size and color and intensity of illumination, so as not to be a distraction to the user when steadily illuminated during normal operation of the different products. Thus, the status indicator configurations 561, 662, 763, 864 of FIGS. 5 through 8, 202 of FIG. 2, and also multi-element configurations such as the indicators 310, 416 of FIGS. 3 and 4 can be located so as to be unobtrusive to the user's view of a display such as indicated at 676, FIG. 6, or other indicating means to be observed by the user during active work with the products. In other embodiments, the indicator can be placed at a location on the device that more directly confronts the user so that it is easier to find and observe.

An important advantage is achieved if the respective light sources or individual elements of the status indicators of FIGS. 1 through 9 are placed under the control of more sophisticated diagnostic programming. For example, actuation of a key or combination of keys, by a technical or non-technical user can be used to run a diagnostic routine. With this additional functionality, a set of diagnostic programs can be placed into operation in sequence by actuation of different keys or combinations of keys, by use of a touch screen or digitizer component, or by the use of spoken commands and the progress and results of each diagnostic step can be signaled to the user with the use of the indicator. If desired, the same status signaling modes as previously discussed (for example, steady off, slow blink, fast blink and steady on) can be used to communicate the results of a diagnostic routine to the user. Alternatively, other signaling schemes such as audio and tactile can be used to communicate when in the diagnostic mode.

The user can be guided through such additional diagnostic sequences by voice, by suitable displayed instructions, or the like, for example, which take account of the information accumulated during normal operation of the status indicators during the various setup sequences previously described. For example, a service technician can communicate successive steps in the advanced diagnostic program based on the user report of the results shown by the status indicators during the regular setup procedures as variously described herein. The service technician can communicate such instructions to the user via telephone or via text messages. Alternatively, the device itself or another device in the system can provide automated instruction to a user by presenting text and or graphical information on a display thereof. Other alternatives include use of a voice instruction program reproduced under the control of the device exhibiting the problem, or under the control of another device of the data handling system, so as to be an efficient diagnosis procedure for such problem based on the events that occurred during the normal setup routine.

Many other methods of guiding the user to initiate the successive steps of an advanced or more precise diagnostic program can also be included. For example, causing a device experiencing a connectivity problem to wirelessly transmit the data from the normal setup procedure to a communication device such as a cell phone or computer having Internet access to a diagnostic computer, that in turn could send the user, as a voice or a text message for example, keypress sequences to be effected to carry out or initiate the advanced diagnostic routine.

It is expected that simpler devices (such as a scanner or slaved peripheral), will in some circumstances require fewer light sources or elements so as to illuminate less than all of the indicator segments of a standard configuration such as is shown in FIG. 3 or FIG. 4, where the more complex network devices may often utilize illumination of all of the indicator segments of the standard configuration such as is shown in FIG. 3 or FIG. 4.

The remainder of this specification will describe various system management features related to the use of the various indicator systems described above. The features disclosed below can be used with any of the indicator, device and system embodiments described above. In short, the features disclosed below can be used, singly or in combination, with any of the embodiments disclosed above in relation to FIGS. 1 through 8.

Referring back to FIG. 1, FIG. 1 illustrates a type of data handling system wherein, for example, a wireless handheld computer 104, 124 can use its radio link to an access point 100, 102 to transfer data (perhaps gathered from a scanned bar code, other optical indicia, or a read RFID tag for example) to a server computer 112. It is also possible in such a system, that the server 112 could process the transmitted data and instruct a printer 114 to create an appropriate label. In such a scenario, the user would have access to the handheld computer 104 or 124 and the printer 114, each of which could have an indicator 122, 106, 130.

As disclosed above, the handheld computer 104, 124 can determine the state of its own indicator (a light element for example) 122, 106 and the printer 114 can determine the state of its own indicator 130. For example, the handheld computer 104, 124 checks its own hardware as well as its connection to an access point 100, 102 and perhaps also its ability to logon to a software application running on the server 112. Determination of the status of the printer's indicator 130 is likely to include for example local hardware checks as well as its supply of ink and forms.

In many data-handling system applications, one device must work in concert with at least one other device of the system to accomplish a desired result. For example, in an application such as a retail price change, a user may use a handheld device such as a handheld computer or a handheld optical indicia reading component to read a bar code, other optical indicia or RFID tag associated with a product. After reading the information, a label related to the read information is created with a printing device of the system and apply the created label is attached to the product. In such applications, a lack of readiness in one device, here the printer 114 creating the label, can be communicated to the user by downgrading or changing the status of the indicator 122, 106 on the handheld computer or reading component in the immediate possession of the user. The changed indicator state is thus consistent with a decreased state of system readiness and is readily available to the user of the handheld device 104, 124.

The preceding paragraph provides an example of how an indicator capable of signaling external system readiness can be used to aid a user and increase efficiency. The term “external system readiness” refers here to the readiness of system devices other than the particular device on which the signaling indicator is housed. Several other similar scenarios also exist wherein an indicator can be used in such a manner. Such examples share the common trait that data available at a management application for example, which is not known to the particular device, is used to change the state of an indicator housed on that device.

Another example scenario involves the empowerment of users of an indicator-equipped system to monitor and maintain that system. In such a case, a readiness failure of any system device can be used to cause a downgrade or a change of the status of the indicator on a select set of handheld computers or other devices of the system. The change in indicator status can be used to alert the user or users that system maintenance, troubleshooting or other action may be required.

The addition of external indications of system readiness to devices containing an indicator enables those devices to more accurately display system readiness. External readiness indications are advantageous because all devices of the system can be considered in determining system readiness. Further, moving a portion of the readiness computation from, for example, an embedded system to a resource rich computing environment enables support for the analysis of systems with large numbers of devices, for more complex and complete “system readiness” analyses, and for complex specification of what is required for the various levels of system readiness.

A software application that monitors or manages the other system devices can itself be a member of that system. System management applications are ideal for supplying an indication of system readiness to the system devices because a primary function of such applications is communication with each system device for the purpose of system analysis. System management applications can reside on a desktop computer or server but may also be migrated into sufficiently robust embedded devices.

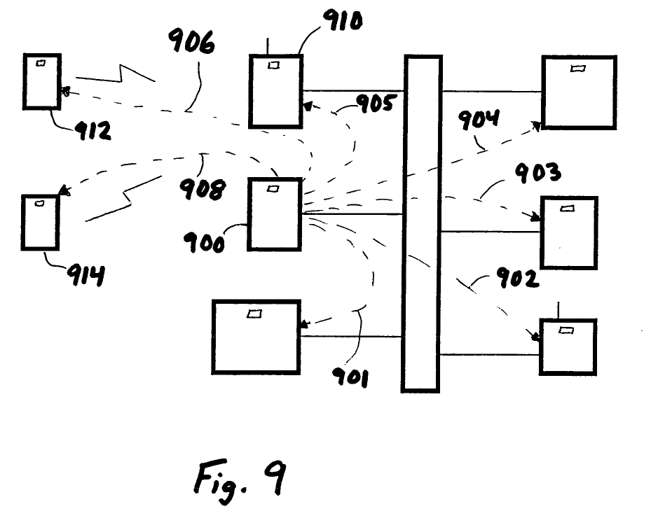

FIG. 9 depicts a system similar to the data-handling system of FIG. 1, but with the addition of a system management application. In the embodiment of FIG. 9, the management application resides on a personal computer 900. As noted above, however, the management application can be resident on any sufficiently robust device of the system. In FIG. 9, the dashed lines 901, 902, 903, 904, 905, 906, 908 indicate the paths of management queries from the device 900 running the management software to all other system devices. An access point 910 often facilitates access to any wireless handheld computers 912, 914. Several management applications are currently available that are suitable for use with the present inventions. Example of such management applications include Hewlett Packard's Open View, IBM's Tivoli, Computer Associate's Unicenter TNG and Intermec Technologies Corporation's Mobile LAN Manager.

The status determination of devices containing an indicator can benefit from the external readiness signals generated by the system management application. The inputs to devices with an indicator should ideally represent a one-to-one relationship with the different states (for example, steady on, slow blink, fast blink and steady off when the indicator is a system light) of the indicator.

Many device, network and system management applications generate a multitude of states to describe the perceived status of any device, including those with system lights. For example, Mobile LAN Manager outputs eleven such states. A signal multiplexer can be used to adapt such management applications to provide input to devices with an indicator having fewer states. The signal multiplexer, which can be a software entity, provides a mapping of system management signals down into the states of the indicator.

Referring to FIGS. 1 and 9 for example, the signal multiplexer can reside in the same device as the management application. In another embodiment, a signal multiplexer can reside in each system device having an indicator. In this latter embodiment, the mapping of the management application signals into indicator states would be accomplished in a device or devices different from the device running the management application. In another embodiment, the signal multiplexer can be a part of the management application. In another embodiment, the management application can be designed to output separate status signals for use by the indicators. In yet another embodiment, the management application can be designed to output the same number of states as will be output by the indicator. In situations where the number of signals output by the management application is equal to the number of states to be communicated by the indicator, no mapping and thus no signal multiplexer will be required.

In embodiments wherein a management application is used to provide enhanced readiness or system status indications, a device with an indicator may have to deal with multiple status indications. First, the device may determine its own readiness. Second, the device may also receive status indications from a management application. When confronted with multiple, differing status indications, the device must have a method for resolving the differing indications and determining which status indication to communicate to the user.

One approach to processing multiple signals relating “readiness” is to determine that readiness is the most severe status. Determination of the worst-case readiness can be mathematically achieved by ranking the various readiness states from most critical to least critical. For example, in an indicator communicating one or four different states of readiness, the ranking can assign a “1” to the inactive (for example, steady off) state, a “2” to the failure (for example, fast blink) state, a “3” to the testing or waiting (for example, slow blink) state, and a “4” to the ready (for example, steady on) state.

The local assessment of readiness as assessed by the device itself, and the signal from additional sources such as the readiness signal from a system management application can be processed via the following method. Using a numerical ranking scheme (such as the one described above for example) the “readiness” input from each of the inputs can be associated with a numerical value. In one embodiment, readiness is determined by choosing the input with the lowest numerical value. Thus, in this embodiment, the state associated with the lowest numerical would be communicated to the user by the indicator. To illustrate this technique, the following table shows the calculation of reported readiness at a device for two readiness input signals and three states of readiness. This approach to determining readiness can be referred to as the “worst case” approach.

TABLE I

| | | System | Reported |
|---|---|---|---|
| | Local readiness | Management | readiness at |
| Example | of this device | readiness | this device |
| 1 | Steady On | Steady On | Steady On |
| 2 | Steady On | Fast Blink | Fast Blink |
| 3 | Steady On | Slow Blink | Slow Blink |
| 4 | Steady On | Steady Off | Steady Off |
| 5 | Fast Blink | Steady On | Fast Blink |
| 6 | Fast Blink | Fast Blink | Fast Blink |
| 7 | Fast Blink | Slow Blink | Fast Blink |
| 8 | Fast Blink | Steady Off | Steady Off |
| 9 | Slow Blink | Steady On | Slow Blink |
| 10 | Slow Blink | Fast Blink | Fast Blink |
| 11 | Slow Blink | Slow Blink | Slow Blink |
| 12 | Slow Blink | Steady Off | Steady Off |
| 13 | Steady Off | Steady On | Steady Off |
| 14 | Steady Off | Fast Blink | Steady Off |
| 15 | Steady Off | Slow Blink | Steady Off |
| 16 | Steady Off | Steady Off | Steady Off |

This “System Management Focus” approach to combining system readiness indications is achieved when a device uses the system management indication of system readiness in combination with the internal self-checks of the device itself in a “worst case” methodology as shown in the table above. In this approach, the device itself does not attempt to determine the system readiness by querying other system elements. This approach offloads the system elements from the processing burden of determining the system status, which may free significant processing and storage resources for embedded systems such as lower-powered handheld computers and access points.

Another embodiment uses a “Client Focus” approach to resolve multiple readiness signals. The “Client Focus” approach to combining system readiness indications is achieved when the device ignores the system readiness input from the system management software, or when such a management application does not exist in the system, and depends solely upon what it knows of itself and other system elements upon which it depends and can query. This setting is required, for example, when connectivity to an external system management application is not possible. It can also be used in other situations as well.

In embodiments using a management application, a periodic message is sent from either the system management application to the device with the indicator or vice versa. The message informs the device with the indicator whether it should expect to accept and process readiness signals from the system management application.

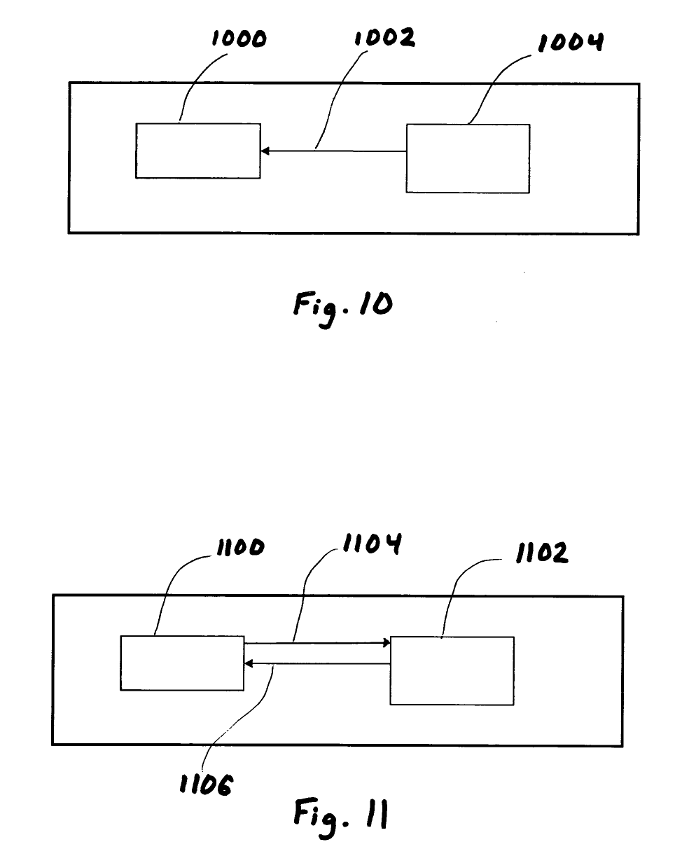

FIGS. 10 and 11 depict two protocols that can be used to communicate with a management application. In FIG. 10, a device with an indicator 1000 periodically receives a readiness indication 1002 from a management application 1004. In this embodiment, the application can automatically send out its readiness indication without requiring that the device request the information. Thus, in contrast to the protocol of FIG. 11, the protocol of FIG. 10 requires only one message be sent, instead of two, each time the readiness information is communicated. In addition, the device having the indicator does not need to persistently retain the configuration of the management application's computer. In fact, there is no additional work required since the knowledge of the devices in the system is information that is routinely maintained by system management applications. In both of the protocols of FIGS. 10 and 11, however, one side must know about the other to initiate the required communications.

FIG. 11 depicts a protocol wherein the device with the indicator 1100 is aware that a management application 1102 may be present in the system. In this embodiment, the device 1100 sends a message 1104 that will trigger a response from the management application 1102 if one is present. If the management application 1102 is present in the system and functional, it will send a reply 1106 to the device with the indicator 1100 to indicate that it is present and that it sends out readiness information pursuant to a specific schedule. An added benefit of the “system management is present” knowledge on the indicator device side may be realized by adding a numeric parameter to that message that sets the system-light device's expectations about how often it expects to receive a “system management is present” signal from the system management application. If desired in either of the protocols of FIG. 10 or FIG. 11, the message from the system management application to the device with the indicator can inform the device with the indicator about how often it should expect to receive such an external readiness signal. If the device with the indicator does not receive another signal from the external management software application after the specified time, the device with the indicator may infer that the system management application has been removed from the system or is otherwise not functioning. In a more refined embodiment, the device with the indicator can wait for the passing of two, or more, non-responsive management periods before making such an inference.

In addition, the indicator-enabled devices can be designed to automatically switch from a “client focus” mode of operation to a “system management focus” mode when a system management application has made itself known to the device with the indicator. Similarly, if the indicator-enabled device infers that the external management application or station has been removed from the system or is not functional, the indicator-enabled device an automatically revert to the “client focus” mode of operation.

The messages in any “device with an indicator” to “management application” protocol, such as the protocols of FIGS. 10 and 11 for example, should be secured against eavesdropping, spoofing, replay and other types of attacks. These messages can be simple messages sent over an SSL (Secure Sockets Layer) or other standard security transports.

The use of a single-element (for example a single light) indicator provides an easier human interface, but it does so at the cost of information precision. To address this reduction in precision while maintaining the spirit of the indicator, the indicator-enabled devices can contain software that can inform a user as to the current stage of operation of the device. The names and order of the phases used can vary widely with different customer usage scenarios, but can be constant for all users in a particular scenario. The state of the indicator can have meaning for each of the phases in the usage scenario. An example of the indicator meaning for an operational phase is related in the following table (Table II).

TABLE II

| Operational | Indicator | |
|---|---|---|
| Phase | State | Meaning |
| Boot-up | Steady On | Self test completed successfully. |
| | | The light will remain in this state |
| | | only momentarily and perhaps |
| | | imperceptibly to the user as the |
| | | “Configuration” phase is usually |
| | | entered immediately upon successful |
| | | completion of the “Boot-up” phase. |
| Boot-up | Slow Blink | Self testing in progress |
| Boot-up | Fast Blink | Failed self test |
| Boot-up | Steady off | Will not occur during “Boot-up” |
| | | phase. The self test will either |
| | | succeed and move to the next phase |
| | | or remain in “Fast Blink” with the |
| | | phase indicator set to “Boot-up”. |

The following table (Table III) lists examples and an example sequence of operational phases for a usage scenario on an indicator-enabled device. Each of these phases is designed to allow the state of the indicator to denote its status.

TABLE III

| Phase | |
|---|---|
| Number | Phase Name |
| 1 | Boot-up |
| 2 | Configuration |
| 3 | Network insertion |
| 4 | Business application Logon |
| 5 | Normal operation |
| 6 | Logout |

Examples of possible meanings for the indicator in each of the operational phases listed above are provided in the following tables (Tables IV through VII). Reasons for entering the different indicator states for each operational phase may also be found in the following tables.

TABLE IV

| Operational | Indicator | |
|---|---|---|
| Phase | State | Meaning |
| Configuration | Steady On | The device is completely and correctly |
| | | configured for the designated |
| | | operational scenario. The light will |
| | | remain in this state only momentarily |
| | | and perhaps imperceptibly to the user |
| | | as the “Network Insertion” phase |
| | | is usually entered immediately upon |
| | | successful completion of the |
| | | “Configuration” phase. |
| Configuration | Slow Blink | Downloading new software or |
| | | downloading new configuration |
| | | parameters or applying new software |
| | | or parameters. |
| Configuration | Fast Blink | Failed to correctly configure the |
| | | device. Possible reasons for entering |
| | | this state include inability to |
| | | download the version number of the |
| | | expected versions of software or |
| | | configuration parameters. This state |
| | | could also be due to an inability to |
| | | download the required versions of |
| | | software or configuration parameters. |
| Configuration | Steady off | Will not occur during |
| | | “Configuration Phase”. |
| | | The configuration will either succeed |
| | | and move to the next phase or remain |
| | | in “Fast Blink” with the phase |
| | | indicator set to “Configuration”. |

TABLE V

| Operational | Indicator | |
|---|---|---|
| Phase | State | Meaning |
| Network | Steady On | This device has passed network |
| Insertion | | authentication and authorization |
| | | (ACL/WEP/802.1x security protocols). At |
| | | this point the access point which the device |
| | | is connected to will permit device |
| | | communication to the business application |
| | | server. The light will remain in this state |
| | | only momentarily and perhaps |
| | | imperceptibly to the user as the “Business |
| | | Application Logon” phase is usually entered |
| | | immediately upon successful completion of |
| | | the “Network Insertion” phase. |
| Network | Slow Blink | Authentication and authorization onto the |
| Insertion | | network are being performed at this time. |
| Network | Fast Blink | Failed to gain access to the network. The |
| Insertion | | most frequent reason for entering this state |
| | | is due to invalid user credentials (username |
| | | and password). Since “Authentication” is |
| | | proving that one is who one claims to be, |
| | | and “Authorization” is the grant of some |
| | | permission (network access) if your identity |
| | | is allowed such permissions. Failures here |
| | | may be due to invalid credentials, or having |
| | | no account in an 802.1x database or |
| | | inability to access the 802.1x server |
| | | amongst other possibilities for failure. |
| Network | Steady off | Will not occur during “Network Insertion” |
| Insertion | | phase. The network insertion will either |
| | | succeed and move to the next phase or |
| | | remain in “Fast Blink” with the phase |
| | | indicator set to “Network Insertion”. |

TABLE VI

| Operational | Indicator | |
|---|---|---|
| Phase | State | Meaning |
| Business | Steady On | The device has successfully logged the |
| Application | | user into the business application running |
| Logon | | on the server. The light will remain in this |
| | | state only momentarily and perhaps |
| | | imperceptibly to the user as the “Normal |
| | | Operation” phase is usually entered |
| | | immediately upon successful completion of |
| | | the “Network Insertion” phase. |
| Business | Slow Blink | Currently attempting login to the business |
| Application | | application on the server. |
| Logon | | |
| Business | Fast Blink | Failed to logon to the business application |
| Application | | on the server. Possible reasons for |
| Logon | | entering this state include: |
| | | 1. The server isn't currently executing |
| | | the desired application. |
| | | 2. There is no account on the server for |
| | | the user of this device. |
| | | 3. The application passwords or other |
| | | credentials used to access the |
| | | business application are invalid. |
| Business | Steady off | Will not occur during “Business Application |
| Application | | Logon” phase. The business application |
| Logon | | logon will either succeed and move to the |
| | | next phase or remain in “Fast Blink” with |
| | | the phase indicator set to “Business |
| | | Application Logon”. |

TABLE VII

| Operational | Indicator | |
|---|---|---|
| Phase | State | Meaning |
| Normal | Steady On | All the steps necessary to use the intended |
| Operation | | application have been satisfied. The user |
| | | is logged in and ready to start working. The |
| | | system light should remain on until such |
| | | time as a logoff occurs or the business |
| | | application kicks the user off for reasons |
| | | such as server shutdown or inactivity |
| | | timeout. |
| Normal | Slow Blink | Testing the system to isolate or resolve a |
| Operation | | potential problem. |
| Normal | Fast Blink | There is an issue with the system that the |
| Operation | | user should know about. Continued |
| | | operation may still be possible. |
| Normal | Steady off | This should never occur in normal |
| Operation | | operation. However, if the user is in the |
| | | “Normal Operation” state and notices that |
| | | the light has gone to “Steady off” it is very |
| | | likely that the user has been logged off the |
| | | system either by the server software or the |
| | | network. It is advised that the user check |
| | | the operational phase to determine if the |
| | | “Logout” phase has been entered. |

TABLE VIII

| Operational | Indicator | |
|---|---|---|
| Phase | State | Meaning |
| Logout | Steady On | This should never occur in this operational |
| | | phase. |
| Logout | Slow Blink | In the process of logging out of the |
| | | business application software and possibly |
| | | the network. |
| Logout | Fast Blink | Logout failure. This indication may have no |
| | | meaning if there is no positive indication |
| | | back to the device signifying that the device |
| | | is now logged off. |
| Logout | Steady off | The device has been successfully logged |
| | | out and extracted from the network. The |
| | | next logical states to enter from this point |
| | | are either “Configuration” or “Network |
| | | Insertion”. |

Breaking the operational time of an indicator-enabled device into phases also provides a distinct opportunity for the device to know when to change the status of its indicator to the “inactive” (for example, steady off) state. The indicator-enabled device can command its indicator to go to a steady off state when the device has logged off of the business application or if it was kicked off the business application due to excessive inactivity timeout or even if the network fails. These reasons are all manifestations of the fact that the device is no longer a capable participant in the business operational segment for which this system was installed.

It should be understood that all of the embodiments described hereinabove are merely illustrative, and that modifications and adaptations will readily occur to those skilled in the art from a consideration of the present disclosure. Such modifications and adaptations are considered to be within the scope of the teachings and concepts of the present inventions.

What is claimed is:

1. A data handling system, comprising:
a first data handling device, comprising a housing and a first communication component;
a second data handling device, comprising a second communication component capable of communicating with said first communication component; and
a first readiness light, located on said housing of said first data handling device;
wherein said first readiness light signals whether the data handling system is ready for use.

2. The data handling system according to claim 1, wherein said first data handling device comprises a portable data collection device having a visual display component and a user-input component.

3. The data handling system according to claim 2, wherein said user-input component comprises a touch screen.

4. The data handling system according to claim 2, wherein said user-input component comprises a digitizer screen.

5. The data handling system according to claim 2, wherein said user-input component comprises a keyboard.

6. The data handling system according to claim 2, wherein said user-input component comprises a voice-input component.

7. The data handling system according to claim 2, wherein said portable data collection device further comprises an integrated optical indicia reader.

8. The data handling system according to claim 1, wherein said first communication component and said second communication component can communicate wirelessly with each other.

9. The data handling system according to claim 1, further comprising a second readiness light located on said second data handling device.

10. The data handling system according to claim 2, wherein said second data handling device comprises a wireless access point.

11. The data handling system according to claim 2, wherein said second data handling device comprises an optical indicia reader.

12. The data handling system according to claim 2, wherein said second data handling device comprises a radio frequency identification tag reader.

13. The data handling system according to claim 2, wherein said second data handling device comprises a personal computer.

14. The data handling system according to claim 1, further comprising a third data handling device, said third data handling device comprising a third communication component.

15. The data handling system according to claim 1, wherein said first readiness light comprises a single light.

16. The data handling system according to claim 1, wherein said first readiness light comprises a plurality of lights.

17. The data handling system according to claim 1, wherein said first readiness light is made to blink to indicate readiness status.

18. The data handling system according to claim 1, wherein said first readiness light is made to change color to indicate readiness status.

19. The data handling system according to claim 1, wherein said first readiness light is essentially continuously illuminated to signal that the data handling system is functioning properly.

20. The data handling system according to claim 1, wherein said first data handling device must be successfully powered up and booted up before said first readiness light will indicate that the data handling system is ready for use.

21. The data handling system according to claim 20, wherein communication between said first communication component and said second communication component must be established before said first readiness light will indicate that the data handling system is ready for use.

22. The data handling system according to claim 1, wherein said first readiness light provides an indication of network connectivity.

23. The data handling system according to claim 20, wherein a peripheral component must be operational and detected before said first readiness light will indicate that the data handling system is ready for use.

24. The data handling system according to claim 20, wherein a properly functioning remotely-located device of the system must be detected before said first readiness light will indicate that the data handling system is ready for use.

25. A computerized device, comprising:
a housing;
a computerized processing system, located in said housing;
a memory component, located in said housing and coupled with said computerized processing system;
a user input component, supported by said housing;
a device readiness light, located on said housing, to signal whether the computerized device is ready for use; and
a diagnostic routine, stored in said memory component;
wherein said diagnostic routine signals results via said device readiness light.

26. The computerized device of claim 25, wherein said device readiness light comprises a single light.

27. The computerized device of claim 25, wherein said device readiness light comprises a plurality of lights.

28. The computerized device of claim 25, wherein said device readiness light is made to blink to indicate readiness status.

29. The computerized device of claim 25, wherein said device readiness light is essentially continuously illuminated to signal that the data handling system is functioning properly.

30. The computerized device of claim 25, wherein the computerized device must be successfully booted up before said device readiness light will indicate that the computerized device is ready for use.

31. The computerized device of claim 30, wherein communication between the computerized and remotely-located device must be established before said device readiness light will indicate that the computerized device is ready for use.

32. The computerized device of claim 25, wherein said device readiness light provides an indication of network connectivity.

33. The computerized device of claim 30, wherein a peripheral component of the computerized device must be operational and detected before said device readiness light will indicate that the computerized device is ready for use.

34. The computerized device of claim 31, wherein a properly functioning remotely-located device must be detected before said device readiness light will indicate that the computerized device is ready for use.

35. The computerized device of claim 25, wherein the computerized device comprises a portable data collection device having a visual display component.

36. The computerized device of claim 25, wherein said user-input component comprises a touch screen.

37. The computerized device of claim 25, wherein said user-input component comprises a digitizer screen.

38. The computerized device of claim 25, wherein said user-input component comprises a keyboard.

39. The computerized device of claim 25, wherein said user-input component comprises a voice-input component.

40. The computerized device of claim 25, wherein the computerized device further comprises an integrated optical indicia reader.

41. The computerized device of claim 25, wherein the computerized device is a wireless access point.

42. The computerized device of claim 25, wherein computerized device is an optical indicia reader.

43. The computerized device of claim 25, wherein the computerized device comprises a radio frequency identification tag reader.

44. The computerized device of claim 25, wherein the computerized device comprises a personal computer.

45. The computerized device of claim 25, wherein said diagnostic routine is initiated from said user-input component.

46. The computerized device of claim 25, further comprising a plurality of different diagnostic routines, each different diagnostic routine designed to check for a different problem.

47. The computerized device of claim 46, wherein one diagnostic routine of said plurality of different diagnostic routines performs a check of a data collection system of the computerized device.

48. The computerized device of claim 46, wherein one diagnostic routine of said plurality of different diagnostic routines performs a check of an application software component of the computerized device.

49. The computerized device of claim 46, wherein one diagnostic routine of said plurality of different diagnostic routines performs a check of a wireless security credential of the computerized device.

50. The computerized device of claim 46, wherein one diagnostic routine of said plurality of different diagnostic routines performs a check of connectivity of the computerized device with an access point.

51. The computerized device of claim 46, wherein one diagnostic routine of said plurality of different diagnostic routines performs a check of an access point serving the computerized device.

52. The computerized device of claim 46, wherein one diagnostic routine of said plurality of different diagnostic routines performs a check of a host computer system serving the computerized device.

53. The computerized device of claim 46, wherein one diagnostic routine of said plurality of different diagnostic routines performs a check of a printer device serving the computerized device.

54. The computerized device of claim 46, wherein one diagnostic routine of said plurality of different diagnostic routines performs a check of a peripheral component of the computerized device.

55. The computerized device of claim 54, wherein said peripheral component comprises an optical indicial reader.

56. The computerized device of claim 54, wherein said peripheral component comprises a radio frequency identification tag reader.

57. The computerized device of claim 54, wherein said peripheral component comprises an additional memory component coupled with the computerized device.

58. A method for troubleshooting a computerized device having a readiness light, comprising the steps of:
signaling a device problem via a readiness light;
initiating a diagnostic procedure via a user interface of the computerized device;
indicating the result of the diagnostic procedure via the readiness light.

59. The method of claim 58, wherein said initiating step comprises pressing at least one key of as keyboard on said computerized device.

60. The method of claim 58, wherein said indicating step comprises illuminating the readiness light.

61. The method of claim 58, wherein said indicating step comprises causing the readiness light to blink.

62. The method of claim 58, wherein said indicating step comprises causing the readiness light to change color.

63. The method of claim 58, wherein the readiness light is essentially continuously illuminated to signal that the device is functioning properly.

64. The method of claim 58, wherein the readiness light comprises a single light.

65. The method of claim 58, wherein the readiness light comprises a plurality of lights.

66. The method of claim 65, wherein each readiness light of said plurality of readiness lights indicates readiness of a different subsystem of the computerized device.

67. The method of claim 58, wherein the initiated diagnostic procedure performs a check of a data collection system of the computerized device.

68. The method of claim 58, wherein the initiated diagnostic procedure performs a check of an application software component of the computerized device.

69. The method of claim 58, wherein the initiated diagnostic procedure performs a check of a wireless security credential of the computerized device.

70. The method of claim 58, wherein the initiated diagnostic procedure performs a check of connectivity of the computerized device with an access point.

71. The method of claim 58, wherein the initiated diagnostic procedure performs a check of an access point serving the computerized device.

72. The method of claim 58, wherein the initiated diagnostic procedure performs a check of a host computer system serving the computerized device.

73. The method of claim 58, wherein the initiated diagnostic procedure performs a check of a printer device serving the computerized device.

74. The method of claim 58, wherein the initiated diagnostic procedure performs a check of a peripheral component of the computerized device.

75. A computerized device, comprising:
means for housing the computerized device;
means for processing computer instructions, located in said means for housing;
means for storing information, located in said means for housing and coupled with said means for processing computer instructions;
means for inputting information from a user, supported by said means for housing;
means for indicating readiness of the computerized device, located on said means for housing; and
means for diagnosing errors, stored in said means for storing information;
wherein said means for diagnosing errors signals results to a user via said means for indicating readiness.

76. A data handling system, comprising:
a first data handling device, comprising a housing and a first communication component;
a second data handling device, comprising a second communication component capable of communicating with said first communication component; and
a first status indicator, located on said housing of said first data handling device;
wherein said first status indicator signals whether the data handling system is ready for use.
